(19) United States
(12) Patent Application Publication
(10) Pub. No.: US 2008/0088610 A1
(43) Pub. Date: Apr. 17, 2008

(54) Driving Circuit of Liquid Crystal Display

(75) Inventors: Lee-Hsun Chang, Hsin-Chu (TW); Jing-Ru Chen, Hsin-Chu (TW); Yu-Wen Lin, Hsin-Chu (TW); Yung-Tse Cheng, Hsin-Chu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORPORATION, Hsin-Chu (TW)

(21) Appl. No.: 11/681,903

(22) Filed: Mar. 5, 2007

(30) Foreign Application Priority Data
Oct. 17, 2006 (TW) 95138253

(51) Int. Cl. G09G 5/00

(52) U.S. Cl. 345/204

(57) ABSTRACT

A driving circuit controlled with a clock signal to drive scan lines of a liquid crystal display includes cascade-connected driving circuit units, and each of the driving circuit units includes an input unit, an output unit, a pull-down circuit, and a control unit. The input unit receives a start signal, and the output unit outputs a driving signal and a carry signal, and the pull-down circuit and the control unit stabilizes the driving signal and the carry signal to prevent the circuit errors.

### RELATED APPLICATIONS

The present application is based on, and claims priority from, Taiwan Patent Application Serial Number 95138253, filed Oct. 17, 2006, the disclosure of which is hereby incorporated by reference herein in its entirety.

### BACKGROUND

1. Field of Invention

The present invention relates to a driving circuit. More particularly, the present invention relates to a driving circuit of a liquid crystal display.

2. Description of Related Art

In recent years, technology has continued to develop significantly and different types of electronic products available change day by day. Among the various electronic products, liquid crystal displays have many advantages such as thin volume, low power consumption, and compatible with current semiconductor fabrication process. So liquid crystal displays have gradually become the mainstream among various candidates of flat panel displays. In the liquid crystal display, the driving circuit is usually one of the important parts. Therefore, how to improve the driving circuit is becoming an urgent issue.

For a recently developed driving circuit of a liquid crystal display, the driving circuit including a plurality of driving circuit units is manufactured on the glass substrate, and the driving circuit units sequentially output the driving signals to the scan lines, so that the conventional driving integrated circuit can be replaced and thus the high cost of using the conventional driving integrated circuit can be reduced. Besides, the outputted driving signal is transmitted to the next driving circuit unit to be the start signal, and transmitted back to the previous driving circuit unit to release the accumulative charges in the circuit and stabilize the outputted driving signal. However, when using this skill, the outputted driving signal has to be transmitted to many circuit loads, so that the outputted driving signal may be incorrect.

The prior art makes each driving circuit unit output an additional carry signal to be the start signal for the next driving circuit unit and to be transmitted back to the previous driving circuit unit to release the accumulative charges in the circuit and stabilize the outputted driving signal. However, the outputted carry signal may be affected by the electrically coupling effect, so that the outputted carry signal is not as correct as expected and may cause the circuit errors.

For the foregoing reasons, there is a need to provide a driving circuit capable of outputting the carry signals steadily to prevent the circuit errors.

### SUMMARY

It is therefore an aspect of the present invention to provide a driving circuit to prevent the circuit errors.

In accordance with one embodiment of the present invention, the driving circuit is controlled with a clock signal to drive a plurality of scan lines of a liquid crystal display, and comprises a plurality of cascade-connected driving circuit units, wherein each of the driving circuit units comprises an input unit, an output unit, a pull-down circuit and a control unit.

The input unit receives a start signal to generate a first signal. The output unit receives the clock signal and the first signal to output a driving signal and a carry signal, wherein the clock signal further comprises a positive phase clock signal and an opposite phase clock signal, phases of which are opposite. The pull-down circuit electrically couples to the input unit, the output unit and a power voltage, and includes a positive phase pull-down circuit, an opposite phase pull-down circuit and a key pull-down circuit. The positive phase pull-down circuit receives the positive phase clock signal to control the output unit, and the opposite phase pull-down circuit receives the opposite phase clock signal to control the output unit, and the key pull-down circuit receives the carry signal outputted from a next driving circuit unit to control the output unit. The control unit electrically couples to the pull-down circuit, the output unit and the power voltage to control the output unit.

Therefore, the driving circuit is capable of stabilizing the outputted driving signals and carry signals and preventing the outputted signals from being affected by the electrically coupling effect and thus causing the circuit errors.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the preferred embodiment, with reference made to the accompanying drawings as follows:

FIG. 1 shows a liquid crystal display panel according to one embodiment of the present invention; and

FIG. 2 shows the driving circuit unit according to the first embodiment of the present invention; and

FIG. 3 shows the driving circuit unit according to the second embodiment of the present invention; and

FIG. 4 shows the driving circuit unit according to the third embodiment of the present invention; and

FIG. 5 is a timing diagram showing the operation of the driving circuit unit according to one embodiment of the present invention.

### DESCRIPTION OF THE PREFERRED EMBODIMENTS

Detailed illustrative embodiments of the present invention are disclosed herein. However, specific details disclosed herein are merely representative for purposes of describing exemplary embodiments of the present invention. This invention may, however, be embodied in many alternate forms and should not be construed as limited to the embodiments set forth herein.

The present invention provides a driving circuit to prevent from being affected by the electrically coupling effect and thus causing the circuit errors.

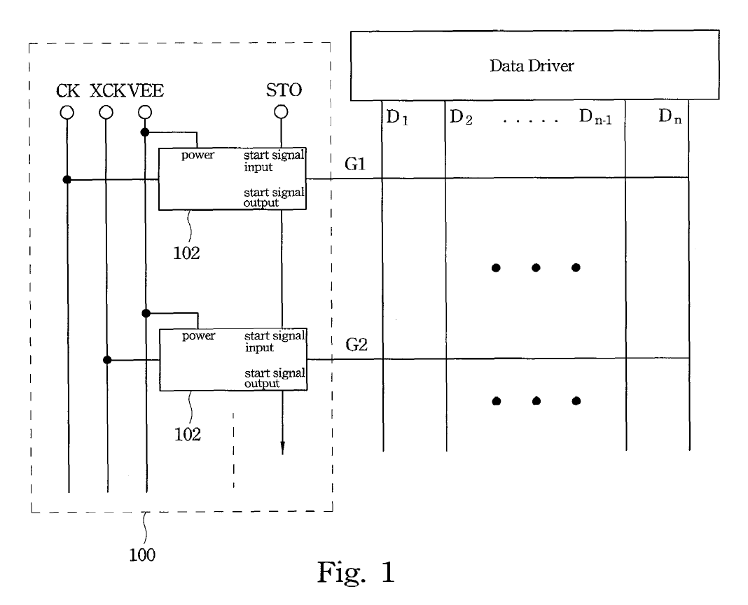

FIG. 1 shows a liquid crystal display panel according to one embodiment of the present invention. Referring to FIG. 1, the driving circuit 100, according to this embodiment, includes a plurality of cascade-connected driving circuit units 102, and each of the driving circuit units 102 is identical. The driving circuit 100 is controlled with a clock signal to drive a plurality of scan lines of a liquid crystal display, and the clock signal is divided into a positive phase clock signal CK and an opposite phase clock signal XCK, phases of which are opposite. One of every two adjacent driving circuit units 102 receives the positive phase clock signal CK and the other one receives the opposite phase clock signal XCK. According to one embodiment, if the N-th driving circuit unit receives the positive phase clock signal CK, the (N+1)-th and the (N−1)-th driving circuit units receive the opposite phase clock signal XCK.

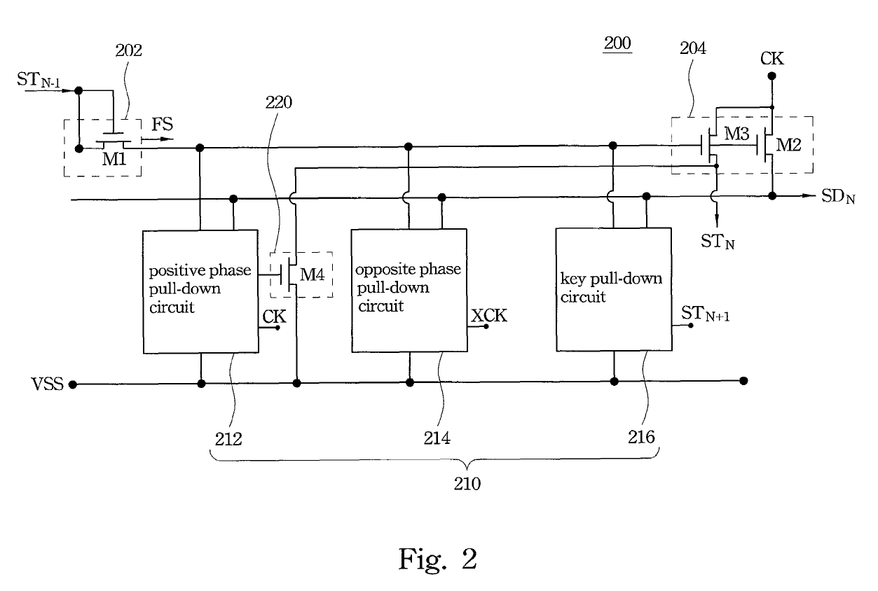

FIG. 2 shows the driving circuit unit according to the first embodiment of the present invention. Referring to FIG. 2 and taking the N-th driving circuit unit 200 for example, the N-th driving circuit unit 200 includes an input unit 202, an output unit 204, a pull-down circuit 210 and a control unit 220, and the pull-down circuit 210 further includes a positive phase pull-down circuit 212, an opposite phase pull-down circuit 214 and a key pull-down circuit 216. In this embodiment, taking the N-th driving circuit unit 200 for example, the output unit 204 receives the positive phase clock signal CK, and outputs a present, say the N-th, driving signal SD_{N} to the scan line, and outputs a carry signal ST_{N} to the next, say the (N+1)-th, driving circuit unit to be the driving signal for the next stage. The input unit 202 receives the carry signal ST_{N-1} outputted from the previous, say the (N−1)-th, driving circuit unit to be the present, say the N-th, driving signal. The input unit 202 electrically couples to the output unit 204 and generates a first signal FS to be transmitted to the output unit 204. On the other hand, the positive phase pull-down circuit 212, the opposite phase pull-down circuit 214 and the key pull-down circuit 216 of the pull-down circuit 210 electrically couple to the input unit 202, the output unit 204 and a power voltage VSS. The positive phase pull-down circuit 212 receives the positive phase clock signal CK to control the output unit 204, and the opposite phase pull-down circuit 214 receives the opposite phase clock signal XCK to control the output unit 204, and the key pull-down circuit 216 receives the carry signal ST_{N+1} outputted from the next driving circuit unit to control the output unit 204. The control unit 220 electrically couples to the positive phase pull-down circuit 212 of the pull-down circuit 210, the output unit 204 and the power voltage VSS to control the output unit 204.

In accordance with the present embodiment, the input unit 202 includes a transistor M1. The gate electrode and the first source/drain electrode of the transistor M1 receive the carry signal ST_{N-1} outputted from the previous, say the (N−1)-th, driving circuit unit, and the second source/drain electrode of the transistor M1 generates the first signal FS to be transmitted to the output unit 204. The output unit 204 includes a transistor M2 and a transistor M3. The gate electrodes of the transistors M2 and M3 electrically couple to the second source/drain electrode of the transistor M1. The first source/drain electrodes of the transistors M2 and M3 receive the positive phase clock signal CK. The second source/drain electrode of the transistor M2 outputs the present, say the N-th, driving signal SD_{N} to the scan line, and the second source/drain electrode of the transistor M3 outputs the present, say the N-th, carry signal ST_{N} to the next, say the (N+1)-th, driving circuit unit to be the driving signal.

On the other hand, the positive phase pull-down circuit 212, the opposite phase pull-down circuit 214 and the key pull-down circuit 216 of the pull-down circuit 210 electrically couple to the second source/drain electrode of the transistor M1, the gate electrodes of the transistors M2 and M3, the second source/drain electrode of the transistor M2 and the power voltage VSS. The positive phase pull-down circuit 212 stabilizes the present driving signal SD_{N} in response to the positive phase clock signal CK, and the opposite phase pull-down circuit 214 stabilizes the present driving signal SD_{N} in response to the opposite phase clock signal XCK, and the key pull-down circuit 216 stabilizes the present driving signal SD_{N} in response to the carry signal ST_{N+1} outputted from the next driving circuit unit. The control unit 220 includes a transistor M4. The gate electrode of the transistor M4 electrically couples to the positive phase pull-down circuit 212, and the first source/drain electrode of the transistor M4 electrically couples to the second source/drain electrode of the transistor M3, and the second source/drain electrode of the transistor M4 electrically couples to the power voltage VSS.

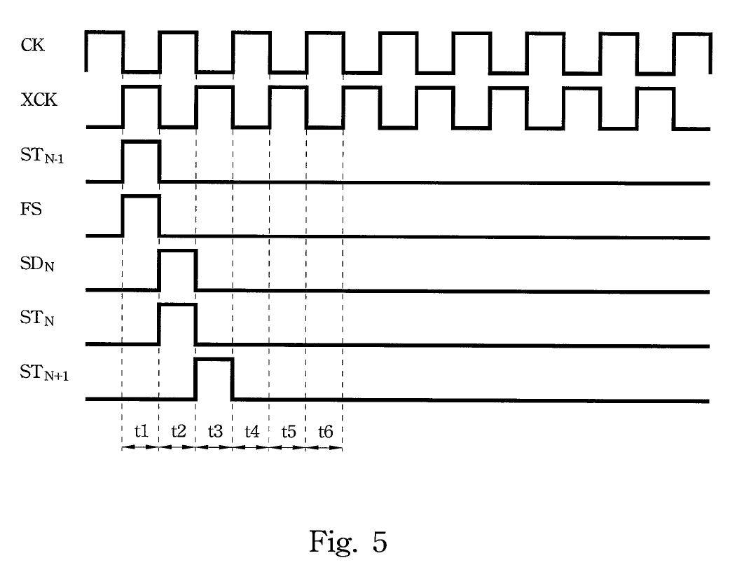

The operation of the driving circuit unit 200 is described as follows. FIG. 5 is a timing diagram showing the operation of the driving circuit unit according to one embodiment of the present invention. Referring to FIG. 2 and FIG. 5 and taking the N-th driving circuit unit 200 for example, during the time period t1, the carry signal ST_{N-1} outputted from the previous, say the (N−1)-th, driving circuit unit is at a high voltage level and transmitted to the gate electrode and the first source/drain electrode of the transistor M1, so as to turn on the transistor M1, and the carry signal ST_{N-1} received by the first source/drain electrode is transmitted to the second source/drain electrode through the transistor M1 to be the first signal FS and transmitted to the transistors M2 and M3.

During the time period t2, the positive phase clock signal CK changes from a low voltage level to a high voltage level and is transmitted to the first source/drain electrodes of the transistors M2 and M3. The gate electrodes of the transistors M2 and M3 receive the first signal FS, so that the transistors M2 and M3 are turned on. Thus, the transistor M2 outputs the positive phase clock signal CK to be the present, say the N-th, driving signal SD_{N} to drive the scan line of the liquid crystal display, and the transistor M3 also outputs the positive phase clock signal CK to be the present, say the N-th, carry signal ST_{N} and transmitted to the next, say the (N+1)-th, driving circuit unit to be the driving signal.

Then during the time period t3, the carry signal ST_{N+1}, generated by the (N+1)-th driving circuit unit which receives the carry signal ST_{N} outputted from the present, say the N-th, driving circuit unit, is transmitted back to the key pull-down circuit 216 of the N-th driving circuit unit, so that the key pull-down circuit 216 is driven and thus releases the accumulative charges of the node Q and stabilizes the driving signal SD_{N}, so as to solve the delay issue of the driving signal SD_{N} and prevent the circuit errors.

In addition, the transistor M4 in the control unit 220 electrically couples to the positive phase pull-down circuit 212. So, when the positive phase clock signal CK triggers the positive phase pull-down circuit 212, the positive phase pull-down circuit 212 works and the transistor M4 is also turned on, so as to stabilize the present carry signal ST_{N} outputted from the transistor M3 and solve the problem that the carry signal ST_{N} is interfered with the coupling effect. Therefore, the circuit errors, due to the coupling effect, can be prevented.

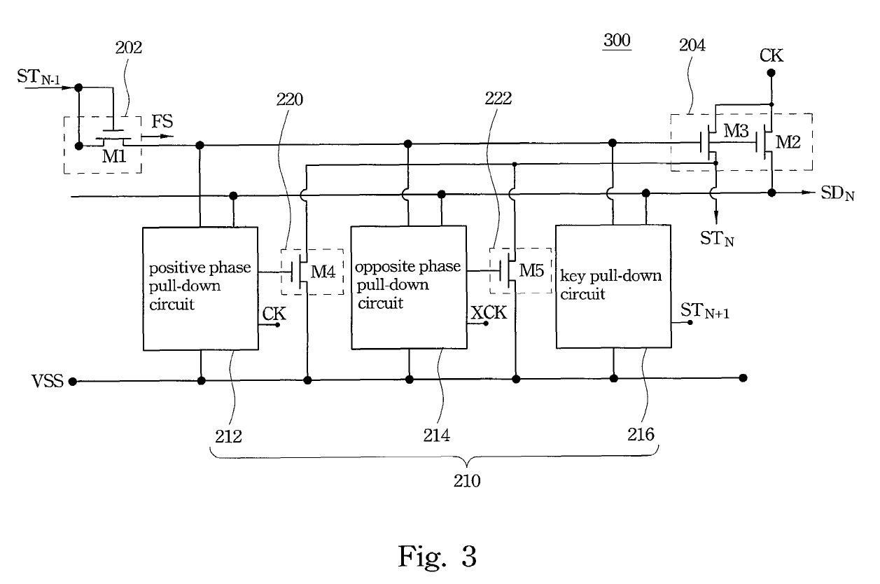

FIG. 3 shows the driving circuit unit according to the second embodiment of the present invention. The most difference between the second embodiment and the first embodiment is that the opposite phase pull-down circuit 214 electrically couples to another control unit 222 as well and the control unit 222 also electrically couples to the output unit 204 and the power voltage VSS to control the output unit 204. The control unit 222 includes a transistor M5, and the gate electrode of the transistor M5 electrically couples to the opposite phase pull-down circuit 214, and the first source/drain electrode of the transistor M5 electrically couples to the second source/drain electrode of the transistor M3, and the second source/drain electrode of the transistor M5 electrically couples to the power voltage VSS.

Further, the operation of the present embodiment is mostly like that of the first embodiment. The most difference is that the transistor M5 in the control unit 222 electrically couples to the opposite phase pull-down circuit 214, so when the opposite phase clock signal XCK triggers the opposite phase pull-down circuit 214, the opposite phase pull-down circuit 214 works and the transistor M5 is also turned on, so as to stabilize the present carry signal ST_{N} outputted from the transistor M3 and solve the problem that the carry signal ST_{N} is interfered with the coupling effect. Therefore, the circuit errors, due to the coupling effect, can be prevented as well.

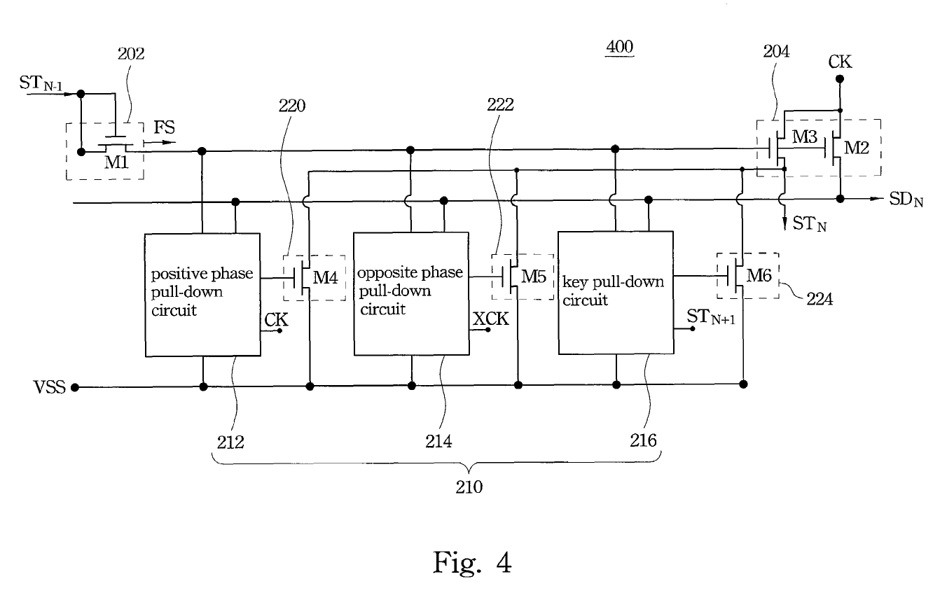

FIG. 4 shows the driving circuit unit according to the third embodiment of the present invention. Compared to the second embodiment, the key pull-down circuit 216 electrically couples to another control unit 224 as well and the control unit 224 also electrically couples to the output unit 204 and the power voltage VSS to control the output unit 204. The control unit 224 includes a transistor M6, and the gate electrode of the transistor M6 electrically couples to the key pull-down circuit 216, and the first source/drain electrode of the transistor M6 electrically couples to the second source/drain electrode of the transistor M3, and the second source/drain electrode of the transistor M6 electrically couples to the power voltage VSS.

Further, the operation of the present embodiment is mostly like that of the second embodiment. The biggest difference is that the transistor M6 in the control unit 224 electrically couples to the key pull-down circuit 216, so when the key pull-down circuit 216 receives the carry signal ST_{N+1} outputted from the next driving circuit unit to be triggered, the key pull-down circuit 216 works and the transistor M6 is also turned on, so as to stabilize the present carry signal ST_{N} outputted from the transistor M3 and solve the problem that the carry signal ST_{N} is interfered with the coupling effect. Therefore, the circuit errors, due to the coupling effect, can be prevented as well.

Except for the foregoing embodiments, the driving circuit unit also can only include the transistor M5 electrically coupling to the opposite phase pull-down circuit 114 or the transistor M6 electrically coupling to the key pull-down circuit 116, or include any two transistors, such as the transistors M4 and M6 or the transistors M5 and M6. The foregoing embodiments of the present invention are illustrated of the present invention rather than limiting of the present invention. As is understood by a person skilled in the art, the various modifications and similar arrangements should be included within the spirit and scope of the appended claims.

Therefore, it is understood from the foregoing embodiments of the present invention, the carry signal can be outputted steadily and the coupling effect affecting the circuit can be reduced to prevent the circuit errors.

As is understood by a person skilled in the art, the foregoing embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A driving circuit controlled with a clock signal to drive a plurality of scan lines of a liquid crystal display, the driving circuit comprising a plurality of cascade-connected driving circuit units, wherein each of the driving circuit units comprises:
an input unit receiving a start signal to generate a first signal;
an output unit receiving the clock signal and the first signal to output a driving signal and a carry signal, wherein the clock signal further comprises a positive phase clock signal and an opposite phase clock signal, phases of which are opposite;
a pull-down circuit electrically coupling to the input unit, the output unit and a power voltage, wherein the pull-down circuit further comprises:
a positive phase pull-down circuit receiving the positive phase clock signal to control the output unit;
an opposite phase pull-down circuit receiving the opposite phase clock signal to control the output unit; and
a key pull-down circuit receiving the carry signal outputted from a next driving circuit unit to control the output unit; and
a control unit electrically coupling to the pull-down circuit, the output unit and the power voltage to control the output unit.

2. The driving circuit of claim 1, wherein the output unit further comprises:
a first transistor, a gate electrode of the first transistor electrically coupling to the input unit to receive the first signal, a first source/drain electrode of the first transistor receiving the clock signal, a second source/drain electrode of the first transistor outputting the driving signal; and
a second transistor, a gate electrode of the second transistor electrically coupling to the input unit to receive the first signal, a first source/drain electrode of the second transistor receiving the clock signal, a second source/drain electrode of the second transistor outputting the carry signal to be the start signal for the next driving circuit unit.

3. The driving circuit of claim 2, wherein the control unit further comprises:
a third transistor, a gate electrode of the third transistor electrically coupling to the positive phase pull-down circuit, a first source/drain electrode of the third transistor electrically coupling to the second source/drain electrode of the second transistor, a second source/drain electrode of the third transistor electrically coupling to the power voltage.

4. The driving circuit of claim 2, wherein the control unit further comprises:
a fourth transistor, a gate electrode of the fourth transistor electrically coupling to the opposite phase pull-down circuit, a first source/drain electrode of the fourth transistor electrically coupling to the second source/drain electrode of the second transistor, a second source/drain electrode of the fourth transistor electrically coupling to the power voltage.

5. The driving circuit of claim 2, wherein the control unit further comprises:
a fifth transistor, a gate electrode of the fifth transistor electrically coupling to the key pull-down circuit, a first source/drain electrode of the fifth transistor electrically coupling to the second source/drain electrode of the second transistor, a second source/drain electrode of the fifth transistor electrically coupling to the power voltage.

6. The driving circuit of claim 2, wherein the positive phase pull-down circuit electrically couples to the gate electrodes of the first and the second transistors, the second source/drain electrode of the first transistor, the input unit and the power voltage.

7. The driving circuit of claim 2, wherein the opposite phase pull-down circuit electrically couples to the gate electrodes of the first and the second transistors, the second source/drain electrode of the first transistor, the input unit and the power voltage.

8. The driving circuit of claim 2, wherein the key pull-down circuit electrically couples to the gate electrodes of the first and the second transistors, the second source/drain electrode of the first transistor, the input unit and the power voltage.

9. The driving circuit of claim 1, wherein the input unit further comprises a transistor, and a gate electrode and a first source/drain electrode of the transistor receive the carry signal outputted from a previous driving circuit unit to be the start signal, and a second source/drain electrode of the transistor outputs the first signal and electrically couples to the output unit.

10. A driving circuit controlled with a clock signal to drive a plurality of scan lines of a liquid crystal display, the driving circuit comprising a plurality of cascade-connected driving circuit units, wherein each of the driving circuit units comprises:
an input unit receiving a start signal to generate a first signal;
an output unit receiving the clock signal and the first signal to output a driving signal and a carry signal, wherein the clock signal further comprises a positive phase clock signal and an opposite phase clock signal, phases of which are opposite;
a first control unit electrically coupling to the output unit, the input unit and a power voltage and controlling the output unit in response to the positive phase clock signal;
a second control unit electrically coupling to the output unit, the input unit and the power voltage and controlling the output unit in response to the opposite phase clock signal;
a third control unit electrically coupling to the output unit, the input unit and the power voltage and controlling the output unit in response to the carry signal outputted from a next driving circuit unit.

11. The driving circuit of claim 10, wherein the output unit further comprises:
a first transistor, a gate electrode of the first transistor electrically coupling to the input unit to receive the first signal, a first source/drain electrode of the first transistor receiving the clock signal, a second source/drain electrode of the first transistor outputting the driving signal; and
a second transistor, a gate electrode of the second transistor electrically coupling to the input unit to receive the first signal, a first source/drain electrode of the second transistor receiving the clock signal, a second source/drain electrode of the second transistor outputting the carry signal to be the start signal for the next driving circuit unit.

12. The driving circuit of claim 11, wherein the first control unit further comprises:
a positive phase pull-down circuit receiving the positive phase clock signal and electrically coupling to the gate electrodes of the first and the second transistors, the second source/drain electrode of the first transistor, the input unit and the power voltage; and
a third transistor, a gate electrode of the third transistor electrically coupling to the positive phase pull-down circuit, a first source/drain electrode of the third transistor electrically coupling to the second source/drain electrode of the second transistor, a second source/drain electrode of the third transistor electrically coupling to the power voltage.

13. The driving circuit of claim 11, wherein the second control unit further comprises:
an opposite phase pull-down circuit receiving the opposite phase clock signal and electrically coupling to the gate electrodes of the first and the second transistors, the second source/drain electrode of the first transistor, the input unit and the power voltage; and
a fourth transistor, a gate electrode of the fourth transistor electrically coupling to the opposite phase pull-down circuit, a first source/drain electrode of the fourth transistor electrically coupling to the second source/drain electrode of the second transistor, a second source/drain electrode of the fourth transistor electrically coupling to the power voltage.

14. The driving circuit of claim 11, wherein the third control unit further comprises:
a key pull-down circuit receiving the driving signal and electrically coupling to the gate electrodes of the first and the second transistors, the second source/drain electrode of the first transistor, the input unit and the power voltage; and
a fifth transistor, a gate electrode of the fifth transistor electrically coupling to the key pull-down circuit, a first source/drain electrode of the fifth transistor electrically coupling to the second source/drain electrode of the second transistor, a second source/drain electrode of the fifth transistor electrically coupling to the power voltage.

15. The driving circuit of claim 10, wherein the input unit further comprises a transistor, and a gate electrode and a first source/drain electrode of the transistor receive the carry signal outputted from a previous driving circuit unit to be the start signal, and a second source/drain electrode of the transistor outputs the first signal and electrically couples to the output unit.
